(19) United States
(12) Patent Application Publication
(10) Pub. No.: US 2010/0176559 A1
(43) Pub. Date: Jul. 15, 2010

(54) GASKET AND GASKET ASSEMBLY FOR SEALING A PROBE IN A DISPOSABLE SYSTEM

(75) Inventors: Charlie Wakeham, Hayling Island (GB); Mark Urbanowski, Southampton (GB)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 12/353,339

(22) Filed: Jan. 14, 2009

(51) Int. Cl. F16L 19/00

(52) U.S. Cl. 277/626

(57) ABSTRACT

A gasket for sealing a probe having a probe head and a probe cable between connector flanges, wherein the probe head has a diameter larger than the probe cable, has a generally annular body. The generally annular body includes an upper surface for sealing against an upper connector flange and a lower surface for sealing against a lower connector flange, and has a generally annular inner wall and a generally annular outer wall, the generally annular inner wall forming an aperture. The generally annular body also includes at least one hinge, the hinge including a radially arranged probe cable insertion port, and a slit. The slit comprises opposing slit sidewalls. When the hinge is open, the slit sidewalls allow the probe cable to be inserted into the probe cable insertion port, and when the hinge is closed, the slit sidewalls contact each other with the probe cable insertion port to form a generally annular seal around the probe cable with the probe head in the aperture.

### BACKGROUND OF THE INVENTION

In many high-purity pharmaceutical systems involving, for example, biotechnology, biopharmaceutical and food processing, probes are used to monitor various parameters of the process stream, e.g., temperature, quantity, pressure, and/or viscosity. However, because these systems must be maintained under aseptic conditions after sterilization, it is important that the probes are sealed without creating entry points wherein contaminants can be introduced into the system.

In view of the foregoing, the inventors of this application have found a way of ameliorating at least some of these concerns. These and other advantages of the present invention will become apparent in light of specification and claims appended hereto.

### BRIEF SUMMARY OF THE INVENTION

An embodiment of the present invention provides a gasket for sealing a probe having a probe head and a probe cable between connector flanges, wherein the probe head has a diameter larger than the probe cable. The gasket comprises a generally annular body. The generally annular body includes an upper surface for sealing against an upper connector flange and a lower surface for sealing against a lower connector flange, and has a generally annular inner wall and a generally annular outer wall, the generally annular inner wall forming an aperture. The generally annular body also includes at least one hinge, the at least one hinge including a radially arranged probe cable insertion port, and a slit. The slit includes opposing slit sidewalls, which allow the probe cable to be inserted into the probe cable insertion port when the at least one hinge is opened, and which contact each other such that the probe cable insertion port forms a generally annular seal around the probe cable with the probe head in the aperture when the at least one hinge is closed.

In another embodiment of the present invention, the gasket comprises a generally annular body comprising a generally annular inner wall and a generally annular outer wall, the generally annular inner wall forming an aperture; an upper surface for sealing against an upper connector flange and a lower surface for sealing against a lower connector flange; at least one slit comprising opposing slit sidewalls formed from the generally annular body and connected by first and second slit ends and having conforming hinges. Each hinge includes a radially arranged probe cable insertion port. When the conforming hinges are opened, the opposing slit sidewalls allow a probe cable to be inserted from the generally annular inner wall through the generally annular outer wall. When the conforming hinges are closed, the opposing slit sidewalls contact each other such that the probe cable insertion ports form a generally annular seal around the probe cable with the probe head in the aperture.

In some embodiments, at least one locating lug may project from a portion of the generally annular outer wall of the gasket.

In accordance with another embodiment, a gasket assembly comprises an upper and lower connector flange and an embodiment of the gasket sealed against the upper and lower connector flanges. For example, the upper surface of the gasket comprises an upper surface face and an upper surface flange extending from the upper surface face, the upper surface flange sealing against the upper connector flange, and the lower surface comprises a lower surface face and a lower flange extending from the lower surface face, the lower flange sealing against the lower connector flange.

In another embodiment, the gasket assembly may include a clamp for drawing the upper and lower connector flanges and the gasket together in a sealed configuration.

A disposable system in accordance with another embodiment of the invention includes an embodiment of a gasket assembly and at least one container in fluid communication with the gasket assembly. Alternatively or additionally, the disposable system in accordance with an embodiment includes at least one filtration device.

In yet another embodiment, a method of monitoring parameters of a pharmaceutical system includes (a) introducing a probe into an embodiment of the gasket assembly; (b) passing a process stream along a fluid flow path through a gasket assembly; and (c) monitoring desired parameters of the pharmaceutical system by the probe before, during, and/or after the process stream has passed through the gasket assembly.

### BRIEF DESCRIPTION OF THE SEVERAL VIEWS OF THE DRAWING(S)

FIGS. 1 and 2 are elevational views of a gasket in accordance with an embodiment of the present invention, wherein the hinges are opened.

FIG. 3 is a partial cut-away view of the probe cable insertion port and locating lug in accordance with an embodiment of the gasket shown in FIGS. 1 and 2, wherein one of the hinges is removed.

FIG. 4 shows another embodiment of the gasket.

FIG. 5 is a side view of the gasket in FIG. 4.

FIGS. 6 and 7 are side views of another embodiment of the gasket. FIG. 6 illustrates an embodiment of the gasket, wherein the hinges are opened. FIG. 7 illustrates an embodiment of the gasket, wherein the hinges are closed.

FIG. 8 illustrates a cross-sectional view of an embodiment of a gasket sealed against upper and lower connector flanges. FIG. 9 illustrates a cross-sectional view of the gasket in FIG. 8, along line A-A.

FIG. 10 is a cross-sectional view of a gasket assembly comprising a clamp according to an embodiment of the invention. FIG. 11 shows a cross-section of the gasket assembly in FIG. 10, along line A-A.

FIGS. 12 and 13 are general schematics of examples of disposable systems using at least one gasket assembly in accordance with an embodiment of the present invention.

### DETAILED DESCRIPTION OF THE INVENTION

An embodiment of the present invention provides a gasket for sealing a probe having a probe head and a probe cable between connector flanges, wherein the probe head has a diameter larger than the probe cable. The gasket comprises a generally annular resilient, elastomeric body, comprising an upper surface for sealing against an upper connector flange and a lower surface for sealing against a lower connector flange; a generally annular inner wall and a generally annular outer wall, the generally annular inner wall forming an aperture; at least one hinge, the at least one hinge including a radially arranged probe cable insertion port; and a slit communicating with the probe cable insertion port, the slit comprising opposing slit sidewalls, the slit sidewalls allowing insertion of the probe cable into the probe cable insertion port when the at least one hinge is open, the slit sidewalls contacting each other such that the probe cable insertion port forms a generally annular seal around the probe cable with the probe head in the aperture when the at least one hinge is closed.

In another embodiment of the present invention, the gasket comprises an annular resilient, elastomeric body comprising a generally annular inner wall and a generally annular outer wall, the generally annular inner wall forming an aperture; an upper surface for sealing against an upper connector flange and a lower surface for sealing against a lower connector flange; conforming hinges, each hinge including a radially arranged probe cable insertion port; and a slit communicating with the probe cable insertion ports, the slit comprising opposing slit sidewalls formed from the resilient elastomeric body and connected by first and second slit ends, the opposing slit sidewalls allowing the insertion of a probe cable from the generally annular inner wall through the generally annular outer wall when the conforming hinges are opened, the opposing slit sidewalls contacting each other such that the probe cable insertion ports form a generally annular seal around the probe cable with the probe head in the aperture when the hinges are closed.

According to some embodiments, the gasket may include at least one locating lug projecting from a portion of the generally annular outer wall. In some embodiments, the probe cable insertion port may include a tapered inner port diameter.

A gasket assembly for sealing a probe having a probe head and a probe cable between connector flanges, wherein the probe head has a diameter larger than the probe cable is provided according to another embodiment of the invention. The gasket assembly comprises an embodiment of the gasket, an upper connector flange and a lower connector flange. According to the embodiment, the upper surface of the gasket has an upper surface face and an upper surface flange extending along the upper surface face for sealing against the upper connector flange, and the lower surface has a lower surface face and a lower surface flange extending along the lower surface face for sealing against the lower connector flange. In some embodiments, the upper connector flange has an upper connector flange end and at least one connector flange recess extending along the upper connector flange end, the at least one upper connector flange recess arranged for mating with the upper surface flange; and the lower connector flange has a lower connector flange end and at least one connector flange recess extending along the lower connector flange end, the at least one lower connector flange recess arranged for mating with the lower surface flange.

According to some embodiments, the gasket assembly can also include a clamp for drawing the upper and lower surface faces of the gasket into a sealed configuration with the upper and lower connector flange ends.

In accordance with another embodiment, a disposable system for processing pharmaceutical process streams comprises an embodiment of the gasket assembly, and at least one container in fluid communication with the gasket assembly. In some embodiments, the disposable system further comprises at least one filtration device.

A method for monitoring desired parameters of a pharmaceutical system comprises (a) introducing a probe into at least one gasket assembly according to an embodiment of the invention; (b) passing a process stream along a fluid flow path through the at least one gasket assembly; and (b) monitoring desired parameters of the pharmaceutical system by the probe before, during, and/or after the process stream has passed through the at least one gasket assembly.

Advantageously, the gasket, in accordance with the present invention, allows probes having probe heads with larger diameters than the probe cable to be effectively sealed in a pharmaceutical processing system without creating entry points where contaminants can be introduced into the process stream once the pharmaceutical processing system has been sterilized.

Each of the components of the invention will now be described in more detail below, wherein like components have like reference numbers.

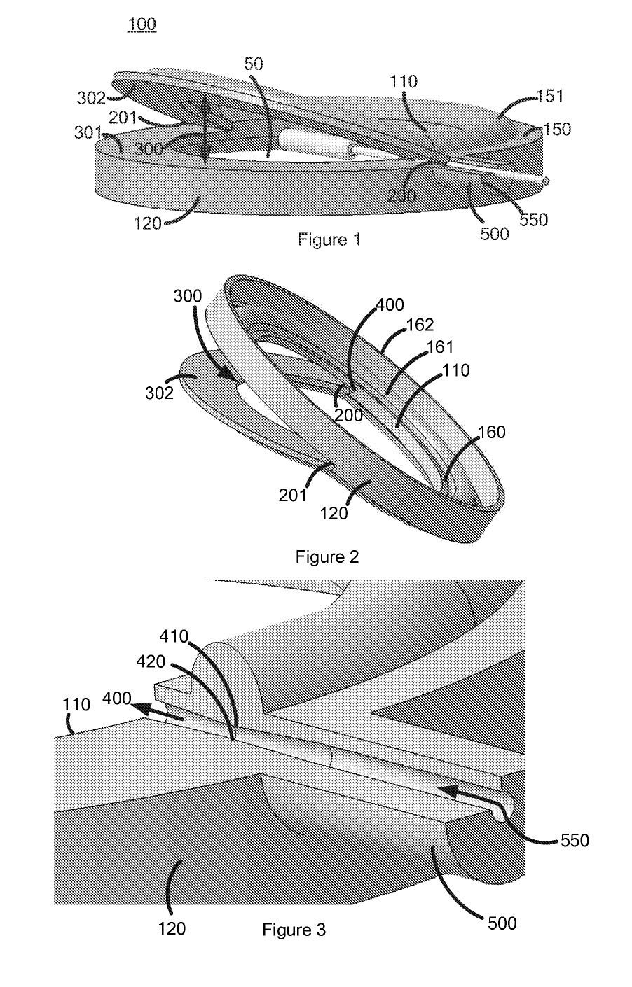

FIGS. 1-3 illustrate an embodiment of the present invention. In FIG. 1, the gasket 100 has a generally annular shaped body having a generally annular inner wall 110, which forms an aperture 50, a generally annular outer wall 120; an upper surface having an upper surface face 150 and an upper surface flange 151 extending along the upper surface face 150; a locating lug 500 extending from the generally annular outer wall 120, the locating lug comprising an access port 550 for accessing the radially arranged probe cable insertion port 400, as described below; hinges 200, 201 extending from the generally annular inner wall 110 through the generally annular outer wall 120; and a slit 300 having opposing slit sidewalls 301, 302, the slit communicating with the probe cable insertion port 400 and extending through the generally annular outer wall 120. As shown in FIG. 2, the illustrated gasket has a lower surface having a lower surface face 160, a lower surface flange 161 extending along the lower surface face 160, and a lower surface flange 162 extending along the outer periphery of the lower surface. Also shown in FIG. 2 are hinges 200, 201, which extend from the generally annular inner wall 110 through the generally annular outer wall 120, wherein hinge 200 includes a radially arranged probe cable insertion port 400; and slit 300 having opposing slit sidewalls (one opposing slit sidewall being shown as 302), the slit communicating with the probe cable insertion port 400 and extending through the generally annular outer wall.

The radially arranged probe cable insertion port (e.g., extending from or toward the generally annular inner wall) can have inwardly tapered port walls or port walls that are not tapered. In an embodiment, as illustrated in FIG. 3, the radially arranged probe cable insertion port 400 has inwardly tapered port walls 410, 420 extending in the direction from the generally annular inner wall 110 through the generally annular outer wall 120. Preferably, the distance between at least a portion of the inwardly tapered port walls 410, 420 is less than the minimum manufactured diameter of the probe cable. Also shown in FIG. 3, a locating lug 500 extends from the generally annular outer wall 120, the locating lug comprising an access port 550 for accessing the probe cable insertion port 400.

Using FIGS. 1-3 as references, hinges 200, 201 are opened (i.e., at least a portion of the opposing slit sidewalls are moved away from each other) and a probe (not shown) having a probe head and a probe cable can be introduced from the generally annular outer wall 120 through the slit sidewalls 301, 302 to the generally annular inner wall 110 such that the probe head is disposed within the aperture 50 and the probe cable extends along the inwardly tapered port walls 410, 420 and the access port 550 of the locating lug 500 (FIG. 3). As hinges 200, 201 are closed (i.e., opposing slit sidewalls contact each other), at least a portion of the inwardly tapered port walls 410, 420 form a generally annular seal around the probe cable with the probe head in the aperture 50.

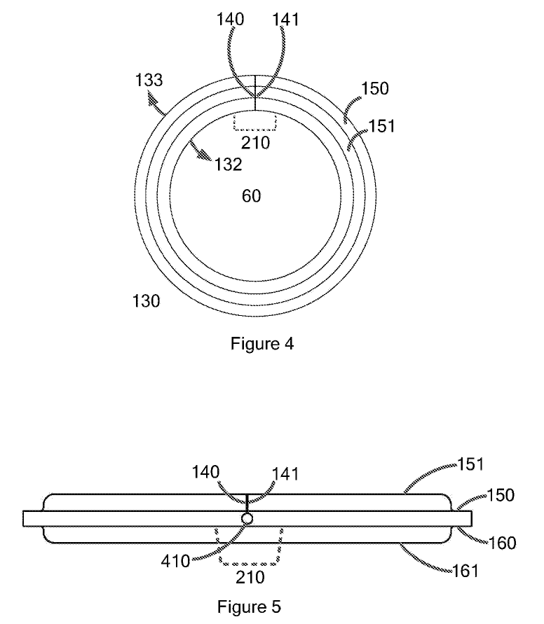

In some embodiments, the at least one hinge can form the top or bottom of the gasket, as shown for example in FIGS. 4 and 5. In FIG. 4, an embodiment of the gasket 130 comprises an upper surface for sealing against an upper connector flange, a lower surface for sealing against a lower connector flange; a generally annular outer wall 133, a generally annular inner wall 132, the generally annular inner wall 132 forming an aperture 60; a hinge 210; and a slit 131 extending from the generally annular inner wall 132 through the generally annular outer wall 133. In the embodiment of the gasket, as illustrated in FIG. 5, the upper surface includes an upper surface face 150 and an upper surface flange 151 extending along the upper surface face 150; the lower surface includes a lower surface face 160 and a lower surface flange 161 extending along the lower surface face 160; the hinge 210 includes a radially arranged probe cable insertion port 410, the hinge forming the bottom of the gasket 130; and the slit communicates with the radially arranged probe cable insertion port 410, the slit comprising opposing slit sidewalls 140, 141. Using FIG. 5 as a reference, as hinge 210 is opened, a probe having a probe head and a probe cable can be introduced along the probe cable insertion port 410 such that the probe head is disposed within the aperture (shown as 60 in FIG. 4) with the probe cable extending along the probe cable insertion port 410. As hinge 210 is closed, the probe cable insertion port 410 forms a generally annular seal around the probe cable with the probe head in the aperture.

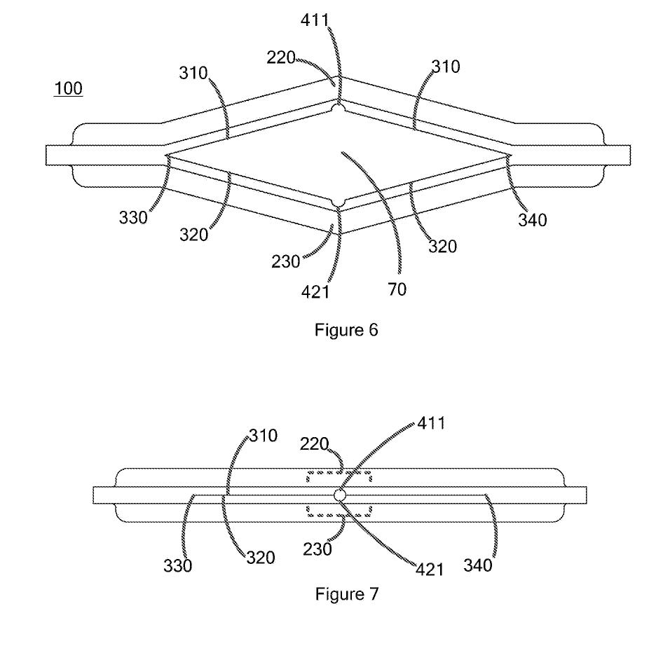

In some embodiments of the invention, the gasket can have any number of hinges. For example, as shown in the embodiment in FIG. 6, gasket 100 includes conforming hinges 220, 230, each including a radially arranged probe cable insertion port 411, 421. Opposing slit sidewalls 310, 320 communicate with radially arranged probe cable insertion ports 411, 421, respectively, and are connected by a first slit end 330 and a second slit end 340. Using FIG. 6 as an illustration, when the hinges 220, 230 are opened, the first slit end 330 and the second slit end 340 are axially moved toward each other such that a gap 70 is formed between the first and second slit ends 330, 340 and hinges 220, 230. The probe head (not shown) can be introduced through a gap 70 into the aperture with the probe cable positioned within the gap 70 and substantially parallel with the probe cable insertion ports 411, 421. When the hinges 220, 230 are closed, the first and second slit ends 330, 340 are axially moved away from each other such that the probe cable insertion ports 411, 421 form a generally annular seal around the probe cable with the probe head in the aperture.

The gasket can be molded from a single-piece of material and made from any variety of suitable compressible and deformable materials so long as the material does not deteriorate or crack under various post-treatment sterilization procedures (for example, autoclaving, gamma irradiation, and chemical cleaning), storage conditions, operating temperatures, and is compatible with the fluid being processed. Preferably, the material is compliant with USP<88> Class VI Bioreactivity tests, ISO 10993, and 21 U.S.C. 177(b). Preferably, the gasket is made from a polymeric resin, more preferably, a resilient, elastomeric resin.

The gasket can also have any suitable thickness and can have any suitable configuration, for example, oval, split-ringed, or any other configuration so long as the gasket provides an effective seal around at least a portion of the probe cable.

The gasket can also have any suitable diameter, preferably conforming to ISO 2852:1993. Preferably, the diameter of the gasket is between the ranges of about 12 mm (about 0.4 inches) to about 219 mm (about 8 inches).

A hinge refers to a region which enables a limited angle of motion between two connected parts, such as, for example, a flexure bearing (e.g., a living hinge). The hinge may be a discrete flexible material used to connect one opposing slit sidewall with the other or may be molded from the same material used to fabricate the gasket.

The probe cable insertion port can be formed by, for example, drilling a hole from, for example, the generally annular inner wall through the generally annular outer wall, or being molded from the same material used in the fabrication of the gasket. The probe cable insertion port can have any suitable configuration so long as at least a portion of the probe cable insertion port forms a seal around at least a portion of the probe cable. In some embodiments, the probe cable insertion port has a generally circular configuration as shown, for example, in FIGS. 1-5. In other embodiments, for example, as shown in FIGS. 6 and 7, the probe cable insertion port has a semi-circular configuration so that when one probe cable insertion port is contacted with an opposing probe cable insertion port, the opposing probe cable insertion ports together form a seal around a probe cable. The diameter of probe cable insertion port can be of any suitable size provided at least a portion of the size is smaller than at least a portion of the outer diameter of the probe cable. The probe cable insertion port can have a tapered diameter, an embodiment of which is shown, for example, in FIGS. 1-3, or can have a constant (or substantially constant) inside diameter, an embodiment of which is shown, for example, in FIGS. 4 and 5.

The slit can be described as a cut where a portion of material is removed or a cut where no material is removed or an opening molded from the same material used in fabricating the gasket. The slit may transverse at least a portion of the generally annular outer wall of the gasket and extend through the generally annular inner wall, for example, as shown in FIGS. 1-3 and 6-7, or may extend from the generally annular inner wall along the upper and/or lower surfaces and through the generally annular outer wall, for example, as shown in FIGS. 4 and 5. The slit can extend non-continuously, in which the slit communicates with, and extends from and/or through the probe cable insertion port at an acute angle. Alternatively or additionally, the slit can extend tangentially to the probe cable insertion port. The gasket according to one embodiment may also include more than one slit.

In any one of the embodiments according to the invention, the gasket can have at least one locating lug. For example, in the embodiment illustrated in FIG. 3, locating lug 500 extends outwardly from the generally annular outer wall 120. The locating lug may be utilized, for example, to align the probe cable insertion port 400 with the clamp opening (as described below). The locating lug can be made from any resilient elastomeric material and sealed to the gasket, but preferably, the locating lug is molded from the same material used in fabricating the gasket. The locating lug can have any cross-sectional configuration, for example, a square or “C”-shaped, or “U”-shaped, tubular or generally circular, provided the locating lug(s) can be fit into the clamp opening (as described below). Preferably, the locating lug includes an access port for providing access to the probe cable insertion port. For example, in the embodiment shown in FIG. 3, access port 550 extends from the generally annular outer wall 120 through locating lug 500. The access port can have any suitable configuration, and can be inwardly tapered or can have a constant (or substantially constant) diameter along the access port.

In some embodiments, the gasket has more than one slit with at least one hinge including a probe cable insertion port so that multiple probes can be simultaneously introduced into the system.

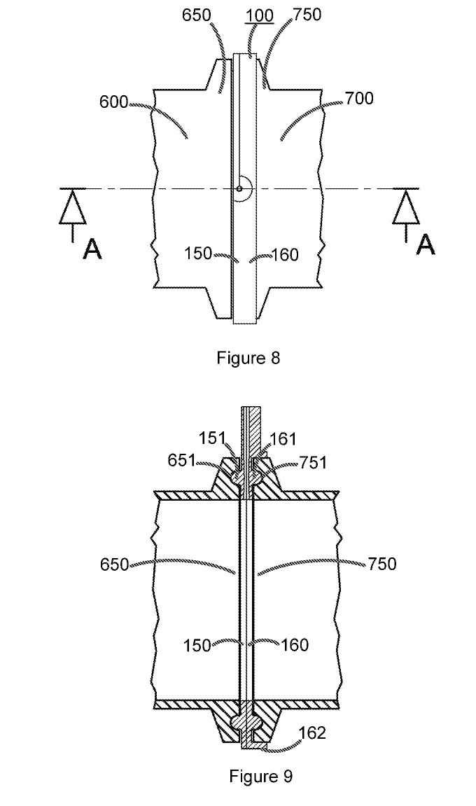

According to an embodiment of the invention, a gasket assembly includes an embodiment of the gasket sealed against upper and lower connector flanges as shown, for example, in FIGS. 8 and 9. In FIG. 8, the gasket assembly comprises an upper connector flange 600 having first and second upper connector flange ends (the first upper connector flange end being shown as 650); a lower connector flange 700 having first and second lower connector flange ends (the first lower connector flange end being shown as 750); and a gasket 100 having an upper surface face 150 sealed against the first upper connector flange end 650 and a lower surface face 160 sealed against the first lower connector flange end 750. In the embodiment, first upper and lower connector flange ends may also include, according to some embodiments, at least one recess extending along the first upper and lower connector flange ends. For example, as illustratively shown in FIG. 9, the first upper and lower connector flange ends 650, 750 include connector flange recesses 651, 751 extending along the first upper and lower connector flange ends 650, 750; and the upper and lower surface faces 150, 160 of gasket 100 include an upper surface flange 151 and a lower surface flange 161, the upper surface flange 151 mating with the first upper connector flange recess 651 and the lower surface flange 161 mating with the first lower connector flange recess 751. The recesses may extend, for example, continuously or intermittently along the first upper and lower connector flange ends. The recesses may also be of any suitable configuration, such as, for example, oval, “C” shaped, segmented, annular shaped. The recesses may have a constant (or substantially constant) diameter or a tapered diameter. Preferably, the recesses extend annularly along at least a portion of the first upper and lower connector flange ends and have a constant (or substantially constant) inner recess diameter.

The upper and lower connector flanges may be of any suitable configuration such as, for example, conical or generally cylindrical. Alternatively or additionally, the upper and lower connector flanges may comprise the inlet of one container and the outlet of another, or an end-cap (e.g., to prohibit connection of any additional elements), or the ends of one or more conduits, or any combination thereof. Preferably, at least the first upper and lower connector flange ends are generally annular and surround an aperture. The upper and lower connector flanges may be formed from any impervious, polymeric material provided the connector flanges are compatible with the fluid being processed and are disposable.

As mentioned above, the upper surface of the gasket has an upper surface face and the lower surface includes a lower surface face. At least one flange can extend from the upper and lower surface faces so that when the gasket is brought into contact with the upper and lower connector flanges, the upper and lower surface flanges seal within the recesses of the upper and lower connector flange ends. Alternatively or additionally, at least one flange extends along the outer periphery of the upper and/or lower surfaces. For example, in the embodiment shown in FIG. 2, the gasket 100 includes a lower surface flange 162 extending along the outer periphery of the lower surface face 160 such that when the gasket is brought into contact with the upper and lower connector flanges (as in the embodiment shown in FIG. 9), the lower surface flange 162 engages at least a portion of the outer periphery of the first lower connector flange end 750. The upper and lower surface flanges can be discrete material connected to the gasket. Preferably, the upper and lower surface flanges are molded from the same material used to fabricate the gasket. The upper and lower surface flanges can have any suitable configuration provided it can seal against the upper and lower connector flange ends.

The generally annular outer wall of the gasket and the outer peripheries of the first upper and lower connector flange ends together can have any total thickness provided it can be sealed within a clamp (as described below). Generally, the total diameter of the generally annular outer wall of the gasket and the outer peripheries of the first upper and lower connector flange ends can be, for example, in the ranges between about 12 mm (about 0.4 inches) to about 219 mm (about 8 inches).

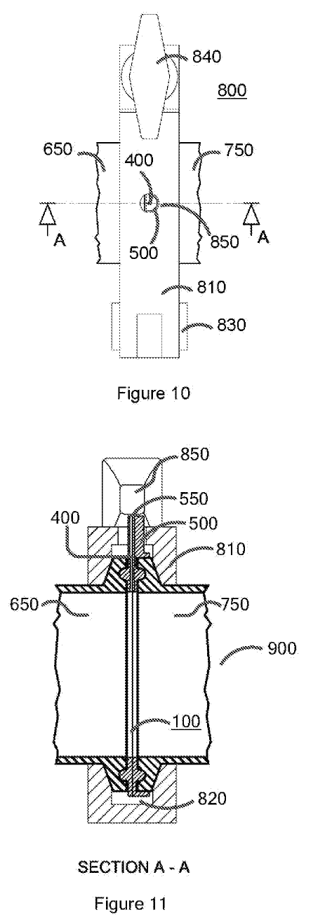

The gasket assembly according to an embodiment of the invention can include additional elements, such as, for example, a clamp for sealing a gasket between the upper and lower connector flanges. Any suitable clamp known in the art can be used in the present invention provided it has opposing tangs hinged together at least at one end and held closed at the other, a clamp port extending through at least one of the tangs, and an inner groove extending along the inside of the opposing tangs; and is disposable. Illustratively, FIG. 10 shows a cross-sectional view of an embodiment of a gasket assembly comprising a clamp 800, which includes opposing semi-circular tangs (one opposing semi-circular tang shown in 810) hinged together at one end by, for example, a pivot pin 830 and connected together at the other end by, for example, a winged screw 840; and a clamp port 850 extending through tang 810, the clamp port providing access to the locating lug 500 (as shown in FIG. 11) and the probe cable insertion port 400. As illustrated in FIG. 11, the clamp 800 also includes an inner groove 820 extending along the inner wall of tang 810 and configured to engage the outer periphery (i.e., the periphery of the first upper and lower connector flange ends and the gasket together) of an embodiment of a gasket assembly 900.

Using FIG. 11 as a reference, a probe can be introduced through clamp port 850 in tang 810 along access port 550 of locating lug 500 and along the probe cable insertion port 400 within the gasket assembly 900 in accordance with an embodiment of the invention. Locating lug 500, including the probe, is introduced through the clamp port 850, and tangs 810, 811 (one opposing semi-circular tang shown as 810) are disposed along the outer periphery of the gasket assembly and connected together by winged screw 840 (as shown in FIG. 10) with the inner groove 820 of the tangs engaging the outer periphery of the gasket assembly. As the winged screw is tightened, the tang ends connected by the winged screw 840 move towards each other and cause the inner groove 820 to draw the first upper and lower connector flanges 650, 750 of the gasket assembly 900 into a sealed configuration with the gasket 100.

The clamp can be fabricated from any suitable rigid, substantially impervious material, including any substantially impervious thermoplastic material. Preferably, the clamp is a hinged clamp. Suitable clamps include, for example, those disclosed in U.S. Pat. No. 6,708,377 and GB Patent No. 2,361,753. The inner groove may have any suitable configuration provided it can engage at least a portion of the outer periphery of an embodiment of the gasket assembly. In some embodiments, the inner groove can extend, for example, continuously or intermittently, e.g., segmented, along the inner wall of the tangs. In some embodiments, the inner groove has a constant (or substantially constant) diameter. Preferably, the inner groove has a tapered configuration.

According to some embodiments, the clamp includes at least one clamp port for introducing a probe through the clamp. The clamp port can be any suitable configuration (e.g., generally circular, oval, square, etc.) provided it allows the passage of a probe through the clamp. The clamp port can be formed by, for example, drilling a hole through the inner wall of the clamp through its outer wall, or can be molded from the same material used in fabricating the clamp. It is contemplated by the inventors that the clamp includes, for example, more than one clamp port so that, if desired, multiple probes can be sealed within the system.

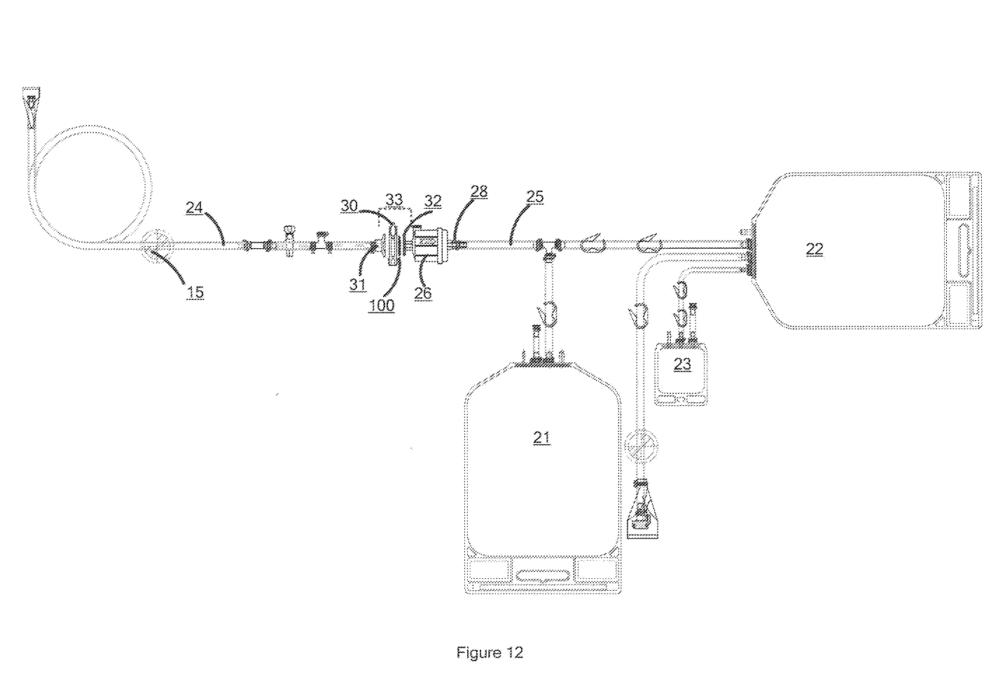

Typically, the gasket assembly according to an embodiment of the invention is included in any disposable pharmaceutical system, e.g., a system including at least one container, such as, for example, a flexible bag, and/or at least one filtration device comprising a porous medium, for processing a pharmaceutical process stream. For example, as shown in FIG. 12, a pharmaceutical process stream can be pumped along conduit 24 via pump 15 through gasket assembly 33 (including an upper connector flange 31, the inlet 32 of filtration device 26, a clamp 30, a gasket 100, and a probe (not shown) sealed within the gasket assembly and connected to a monitoring device (not shown)) via the upper connector flange 31, along a fluid flow path in the gasket assembly 33 across the probe. The probe can monitor the desired parameters of the pharmaceutical system before, during, and/or after the process stream has passed through the gasket assembly 33 and transmits a signal to the monitoring device. The process stream is subsequently passed through the inlet 32 into filtration device 26. As the process stream passes through the filtration device 26, the process stream passes through the medium and a portion of the process stream is selectively retained by the medium, and the remaining process stream exits via outlet 28 of the filtration device 26 along a fluid flow path via conduit 25 and subsequently collected into at least one container, for example, one or more collection bags 21, 22, 23.

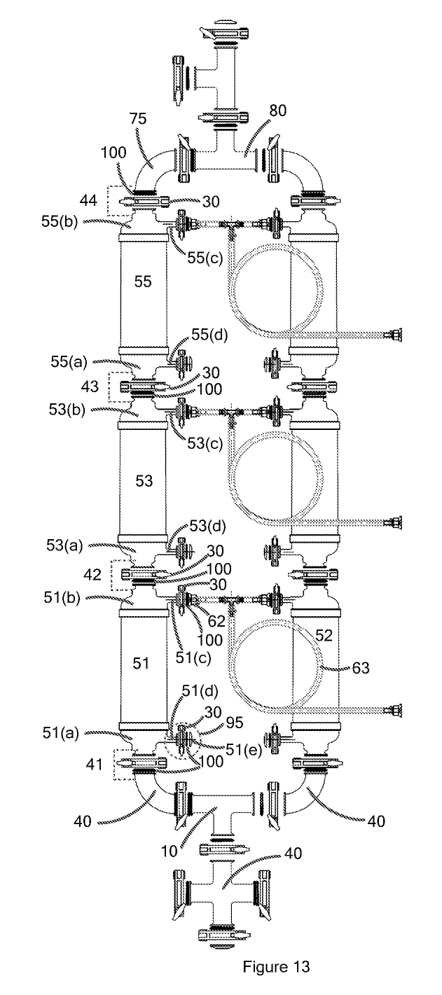

According to an embodiment of the invention, a pharmaceutical process stream can be passed along one or more conduits through one or more gasket assemblies. For example, using FIG. 13 (particularly with regards to gasket assembly 41 and filtration device 51) as a reference, a pharmaceutical process stream can be passed along inlet conduit 40 through gasket assembly 41. While in the gasket assembly, the process stream passes along a fluid flow path within the gasket assembly, which includes one end of conduit 40 and the inlet of filtration device 51(a); a clamp 30; a gasket 100; and a probe (not shown) sealed within the gasket assembly and connected to a monitoring device (not shown), across the probe and enters the filtration device 51 via inlet 51(a). Within the filtration device 51, the process stream can be passed tangentially across the upstream surface of the porous medium to allow a portion of the process stream, e.g., the first permeate, to pass through the medium and exit the first permeate port 51(c) while the other portion of the process stream, e.g., the first retentate, exits the filtration device 51 via the outlet 51(b) of filtration device 51.

Alternatively or additionally, the one or more filtration devices may be connected by an embodiment of the gasket assembly. For example, continuing with FIG. 13, the first retentate passes from filtration device 51 through gasket assembly 42 via outlet 51(b) of filtration device 51, the gasket assembly 42 including outlet 51(b) of filtration device 51, the inlet 53(a) of filtration device 53; a clamp 30; a gasket 100; and a probe (not shown) sealed within the gasket assembly 42 and connected to a monitoring device (not shown). While in the gasket assembly 42, the first retentate passes across the probe along a fluid flow path and enters filtration device 53 through inlet 53(a) of filtration device 53. Within filtration device 53, the first retentate from filtration device 51 is passed tangentially across the upstream surface of the porous medium to allow a portion of the first retentate, e.g., the second permeate, to pass through the medium and exit the second permeate port 53(c) while the other portion of the first retentate, e.g., the second retentate, exits the filtration device 53 via outlet 53(b) of the filtration device 53. The second retentate can then be passed from filtration device 53 through gasket assembly 43 via outlet 53(b) of the filtration device 53, the gasket assembly 43 including the outlet 53(b) of filtration device 53, the inlet 55(a) of filtration device 55; a clamp 30; a gasket 100; and a probe (not shown) sealed within the gasket assembly 43 and connected to a monitoring device (not shown). Within the gasket assembly 43, the second retentate passes across a probe along a fluid flow path and enters filtration device 55 via inlet 55(a) of filtration device 55. While in the filtration device 55, the second retentate from filtration device 53 is passed tangentially across the upstream surface of the porous medium to allow a portion of the second retentate, e.g., the third permeate, to pass through the medium and exit the third permeate port 55(c) while the other portion of the second retentate, e.g., the third retentate, exits the filtration device 55 via outlet 55(b) of filtration device 55. In some embodiments, the third retentate may be passed through gasket assembly 44 via outlet 55(b) of filtration device 55, the gasket assembly 44 including the outlet 55(b) of filtration device 55, an end of outlet conduit 75; a clamp 30; a gasket 100; and a probe (not shown) sealed within the gasket assembly 44 and connected to a monitoring device (not shown) Within the gasket assembly 44, the third retentate is passed across the probe along a fluid flow path along outlet conduit 75 and exits outlet 80.

Alternatively or additionally, one or more gasket assemblies can be included at one or more permeate ports. Again using FIG. 13 and filtration device 51 as a reference, once the first permeate passes through the porous medium in filtration device 51, the first permeate can be passed through a gasket assembly 41, the gasket assembly including the first permeate port 51(c), lower connector flange 62; a clamp 30; a gasket 100; and a probe (not shown) sealed within the gasket assembly and connected to a monitoring device (not shown). The first permeate is passed across the probe along a fluid flow path along the lower connector flange 62 and exits the system through permeate conduit 63.

The pharmaceutical process stream may flow in a forward direction (e.g., process stream is passed from inlet 10 of the disposable system through one or more rows of serially arranged filtration devices (for example, filtration devices 51, 53, 55) and exits at outlet 80) or in a reverse direction (e.g., process stream is passed from inlet 80 of the disposable system through one or more rows of serially arranged filtration devices (for example, filtration devices 55, 53, 51) and exits at outlet 10). In cases where the process stream flows in a forward direction, the permeate ports (e.g., 55(d), 53(d), and 51(d)) near the inlet of each filtration device may not be utilized, in which case, the gasket assembly disposed along the permeate port may include an end-cap, which is shown in FIG. 13 as 51(e) in gasket assembly 45. In any one of the embodiments, the probe can monitor the desired parameters of the pharmaceutical system before, during, and/or after the process stream passes through a gasket assembly and transmits a signal to the monitoring device.

Various suitable conduits and containers are known in the art such as, for example, conduits and containers made from, for example, plasticized polyvinyl chloride, or ethylene butyl acrylate copolymer (EBAC) resin, ethylene methyl acrylate copolymer (EMAC), resin, plasticized ultra-high-molecular weight PVC resin, and ethylene vinyl acetate (EVA). The conduits and/or containers can also be formed from, for example, polyolefin, polyurethane, polyester, and polycarbonate. Suitable conduits are commercially available, for example, from Saint Gobain Performance Plastics (Clearwater, Fla.). For example, conduits commercially available from Saint Gobain Performance Plastics are referred to as C-Flex®.

In some embodiments, conduits can be, for example, non-flexible or substantially non-flexible. For example, such conduits can be fabricated from any suitable rigid impervious material, including, for example, any impervious thermoplastic material, e.g., an impervious thermoplastic pipe. For example, the conduit can be a polymer, such an acrylic, polypropylene, polystyrene, or a polycarbonated resin.

According to the invention, any type of filtration device known in the art can be used, provided the filtration device comprises a housing comprising an inlet and an outlet and defining a fluid flow path between the inlet and the outlet, and a porous medium disposed within the housing and along the fluid flow path. For example, a filtration device according to an embodiment of the invention can be a tangential flow filtration device, or a single-pass filtration device, e.g., a virus filter. Illustrative filtration devices are disclosed in, for example, U.S. Pat. No. 7,273,550 and WO 2005/094963.

Any suitable probe can be used in the present invention. Preferably, the probe has a probe head and a probe cable extending from the probe head and connected to a monitoring device. Typically, the probe head has a larger diameter than the probe cable. Generally the probe cable has an outer diameter of about 0.9 mm (about 0.3 inches), but the outer diameter can between the ranges of about 0.75 mm (about 0.1 inches) to about 1 mm (about 0.1 inches). The probe cable can also have a variable outer diameter along its length. Typically the probe head comprises a housing and a sensor disposed within the housing. The fiber optic sensor can be used to monitor, for example, temperature, pressure, viscosity, and/or any other desired physical or chemical system parameter now known or later developed in the art. For example, before, during, and/or after the pharmaceutical process stream passes through the probe head in accordance with an embodiment of the invention, the sensor sends a signal, e.g., by way of a signal conductor or wirelessly, to a monitoring device respecting the desired parameter to be monitored. The inventors have contemplated using more than one probe simultaneously in the system, but it has not been rigorously proven and therefore the invention should not be limited to this or any other theory.

The monitoring device according to an embodiment of the invention can be any suitable device known in the art provided the monitoring device can receive the signal from the probe. The monitoring device can be, for example, a stand-alone device or may be a component of a larger system, e.g., a computer system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gasket for sealing a probe having a probe head and a probe cable between connector flanges, wherein the probe head has a larger diameter than the probe cable, comprising:
a. a generally annular resilient, elastomeric body, comprising:
i. an upper surface for sealing against an upper connector flange and a lower surface for sealing against a lower connector flange;
ii. a generally annular inner wall and a generally annular outer wall, the generally annular inner wall forming an aperture;
iii. at least one hinge, the hinge including a radially arranged probe cable insertion port; and
iv. a slit, the slit communicating with the probe cable insertion port, the slit comprising opposing slit sidewalls, the slit sidewalls allowing insertion of the probe cable into the probe cable insertion port when the hinge is open, the slit sidewalls contacting each other such that the probe cable insertion port forms a generally annular seal around the probe cable with the probe head in the aperture when the hinge is closed.

2. A gasket for sealing a probe having a probe head and a probe cable between connector flanges, wherein the probe head has a larger diameter than the probe cable, comprising:
a. generally annular resilient, elastomeric body, comprising:
i. an upper surface for sealing against an upper flange and a lower surface for sealing against a lower connector flange;
ii. a generally annular inner wall and a generally annular outer wall, the generally annular inner wall forming an aperture;
iii. a slit, the slit comprising opposing slit sidewalls formed from the resilient elastomeric body and connected by a first slit end and a second slit end and having conforming hinges, each hinge including a radially arranged probe cable insertion port, the opposing slit sidewalls allowing the insertion of the probe cable from the generally annular inner wall through the generally annular outer wall when the conforming hinges are closed, the opposing slit sidewalls contacting each other such that the probe cable insertion ports form an annular seal around the probe cable with the probe head in the aperture when the hinges are opened.

3. A gasket as in claim 1, further comprising at least one locating lug extending outwardly from at least a portion of the generally annular outer wall.

4. A gasket as in claim 3, wherein the at least one locating lug comprises an access port.

5. A gasket as in claim 1, wherein the probe cable insertion port comprises inwardly tapered port walls.

6. A gasket as in claim 1, wherein the upper surface further comprises an upper surface face and at least one flange extending along the upper surface face.

7. A gasket as in claim 1, wherein the at least one flange extends along the outer periphery of the upper surface.

8. A gasket as in claim 1, wherein the lower surface further comprises a lower surface face and at least one flange extending along the lower surface face.

9. A gasket as in claim 1, wherein the at least one flange extends along the outer periphery of the lower surface.

10. A gasket assembly for sealing a probe having a probe head and a probe cable between connector flanges, wherein the probe head has a larger diameter than the probe cable, comprising:
a. an upper connector flange, comprising an upper connector flange end;
b. a lower connector flange, comprising a lower connector flange end; and
c. a gasket according to claim 1, disposed between the upper connector flange end and the lower connector flange end, the at least one upper surface flange sealing against the at least one upper connector flange end, the at least one lower surface flange sealing against the at least one lower connector flange end.

11. A gasket assembly as in claim 10, wherein the upper connector flange further comprises at least one recess extending along the upper connector flange end.

12. A gasket assembly as in claim 11, wherein the at least one upper surface flange mates with the at least one upper connector flange recess.

13. A gasket assembly as in claim 10, wherein the lower connector flange further comprises at least one recess extending along the lower connector flange end.

14. A gasket assembly as in claim 13, wherein the at least one lower surface flange mates with the at least one lower connector flange recess.

15. A gasket assembly as in claim 10, further comprising a clamp for drawing the upper and lower surface faces of the gasket into a sealed configuration with the upper and lower connector flange ends.

16. A disposable system for processing a pharmaceutical process stream, comprising:
a gasket assembly in accordance to claim 10; and
at least one container in fluid communication with the gasket assembly.

17. A disposable system, as in claim 16, further comprising at least one filtration device in fluid communication with the gasket assembly.

18. A disposable system for processing a pharmaceutical process stream, comprising:
a gasket assembly in accordance to claim 10; and
at least one filtration device in fluid communication with the gasket assembly.

19. A method for monitoring desired parameters of a pharmaceutical system, comprising:
introducing a probe into a gasket assembly in accordance to claim 10;
passing a process stream along a fluid flow path through a gasket assembly; and
monitoring desired parameters of the pharmaceutical system by the probe before, during, and/or after the process stream has passed through the gasket assembly.
